(19) United States
(12) Patent Application Publication
(10) Pub. No.: US 2024/0154630 A1
(43) Pub. Date: May 9, 2024

(54) COMMUNICATION DEVICE

(71) Applicant: MITAC COMPUTING TECHNOLOGY CORPORATION, Taoyuan City (TW)

(72) Inventor: Chien-Chih CHIU, Taoyuan City (TW)

(73) Assignee: MITAC COMPUTING TECHNOLOGY CORPORATION, Taoyuan City (TW)

(21) Appl. No.: 18/298,431

(22) Filed: Apr. 11, 2023

(30) Foreign Application Priority Data
Nov. 4, 2022 (TW) 111142299

(51) Int. Cl. H04B 1/00

(52) U.S. Cl. CPC H04B 1/0064

(57) ABSTRACT

A communication device is adapted to be coupled to an external antenna configured to receive a wireless signal in a frequency band. The communication device includes a connector, an internal antenna, a switch, a wireless communication module, and a controller. The connector is adapted to be coupled to the external antenna. The internal antenna is configured to receive the wireless signal in the frequency band. The switch is selectively coupled to the connector or the internal antenna. The wireless communication module is coupled to the switch, and is configured to generate a signal strength indicator parameter based on the wireless signal in the frequency band. The controller is configured to control switching of the switch based on the signal strength indicator parameter.

### CROSS-REFERENCE TO RELATED APPLICATION

This non-provisional application claims priority under 35 U.S.C. § 119(a) to Patent Application No. 111142299 filed in Taiwan, R.O.C. on Nov. 4, 2022, the entire contents of which are hereby incorporated by reference.

### BACKGROUND

### Technical Field

The present disclosure relates to a communication device, and in particular, to a wireless signal communication device.

### Related Art

Currently, there is a gateway adapted to be deployed in different environments according to different communication demands. In order to adapt to different application environments, the gateway is equipped with an explosion-proof housing to prevent damage. The explosion-proof housing is generally made of metal to provide sufficient strength. During testing, the applicant found that if an internal antenna is used in the gateway, the metal explosion-proof housing causes a shielding problem, resulting in poor signal reception quality of the internal antenna.

### SUMMARY

Based on the above, the applicant provides a communication device adapted to be coupled to an external antenna. The external antenna is configured to receive a first wireless signal in a first frequency band. The device includes a first connector, a first internal antenna, a first switch, a first wireless communication module, and a controller. The first connector is adapted to be coupled to the external antenna. The first internal antenna is configured to receive a wireless signal in a first frequency band. The first switch is selectively coupled to the first connector or the first internal antenna. The first wireless communication module is coupled to the first switch. The first wireless communication module is configured to generate a first signal strength indicator parameter based on the wireless signal in the first frequency band. The controller is configured to control switching of the first switch based on the first signal strength indicator parameter.

### BRIEF DESCRIPTION OF THE DRAWINGS

FIG. 1 is a three-dimensional perspective view of a communication device according to some embodiments of the present disclosure.

FIG. 2A is a top perspective view of a communication device according to some embodiments of the present disclosure.

FIG. 2B is a schematic top view of the communication device coupled to an external antenna according to some embodiments of the present disclosure.

FIG. 3 is a schematic block diagram of a communication device according to some embodiments of the present disclosure.

FIG. 4 is a schematic block diagram of a communication device according to some other embodiments of the present disclosure.

### DETAILED DESCRIPTION

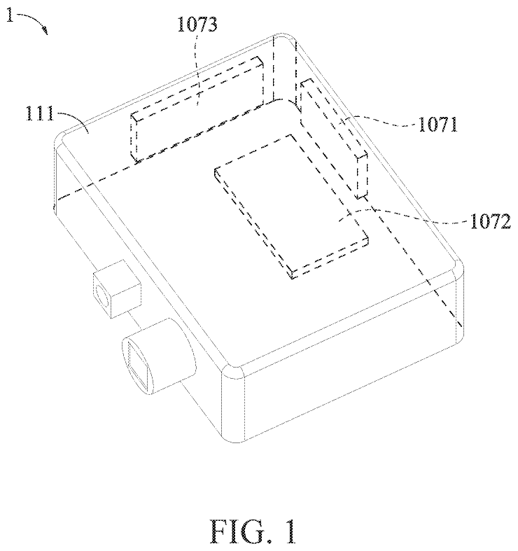

FIG. 1 is a three-dimensional perspective view of a communication device according to some embodiments of the present disclosure. Referring to FIG. 1, the communication device 1 includes a housing 111 and an internal antenna arranged in the housing 111. A plurality of internal antennas may be arranged, such as a first internal antenna 1071, a second internal antenna 1072, and a third internal antenna 1073 shown in FIG. 1, to meet different communication requirements. The communication device 1 may be a device adopts wireless communication, such as a gateway, a router, a bridge, a network switch, a repeater, or a wireless network access point, but the present disclosure is not limited thereto. The internal antenna 1071, 1072, 1073 is adapted to receive a wireless signal in a specified frequency band, so as to meet signal transmission frequency requirements of different communication protocols. In some embodiments, the communication device 1 includes a plurality of internal antennas adapted to receive wireless signals in the same frequency band range or different frequency band ranges. For example, the first internal antenna 1071 shown in FIG. 1 is adapted to receive a 2.4 GHz Wi-Fi signal, the second internal antenna 1072 is adapted to receive a sub-GHz signal less than 1 GHz, and the third internal antenna 1073 is adapted to receive a 2.4 GHz Bluetooth signal.

In some embodiments, a user carries or deploys the communication device 1 in different environments. For example, the user uses the communication device 1 at home and carries the communication device 1 to a hotel or a workplace on business. In response to the above requirements, the housing 111 of the communication device 1 needs to be made of a solid material. In some embodiments, the housing 111 is made of a metal material, such as aluminum, magnesium, titanium alloy, or stainless steel, to avoid damage to the communication device 1 caused by falling during the carrying, or to avoid damage to the communication device 1 in a mounting environment, such as damaged caused by a pet at home. In this some embodiment, the metal housing 111 causes a shielding effect which affects communication quality of the internal antenna. In particular, in a usage environment where strength of a specific wireless signal is poor, the internal antenna may fail to receive the specific wireless signal.

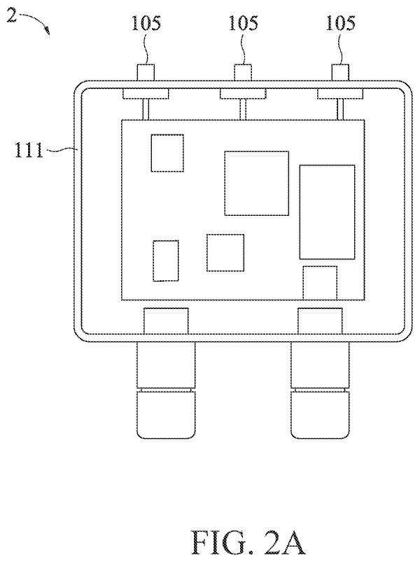

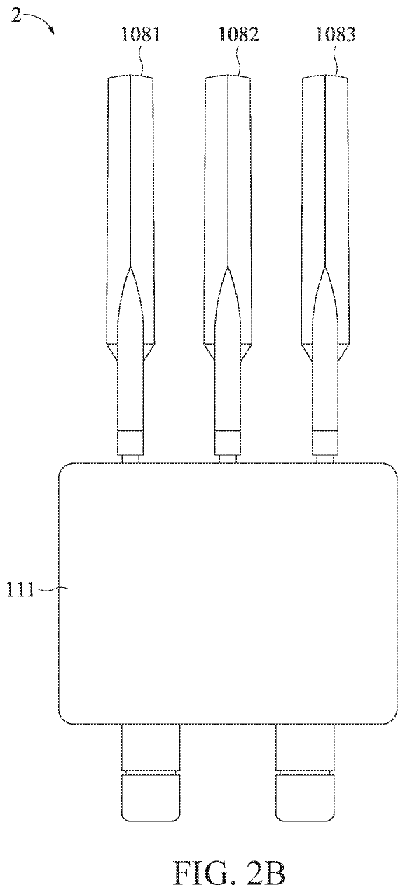

Referring to FIG. 2A and FIG. 2B, in some embodiments, the communication device 2 includes a connector 105 arranged in the housing 111. The connector 105 is adapted to be coupled to an external antenna, and the external antenna may be removed from the connector 105 during carrying or when not used. As mentioned above, the communication quality of the internal antenna may be affected by the material of the housing 111, but the exposed external antenna can solve the problem about the communication quality. In the embodiment of FIG. 2A and FIG. 2B, a communication device 2 includes three connectors 105, which respectively correspond to a first external antenna 1081, a second external antenna 1082, and a third external antenna 1083.

The connectors 105 provide an option for a user to determine whether to mount the external antenna 1081, 1082, 1083, especially for a user who needs to carry the communication device 2 out. Specifically, the user finds that the signal strength of a Wi-Fi signal (2.4 GHz), a Bluetooth signal (2.4 GHz), and a sub-GHz signal (<1 GHz) in a room of the home is poor based on past experience. Therefore, the first external antenna 1081, the second external antenna 1082, and the third external antenna 1083 need to be mounted in the communication device 2 to replace the internal antenna. The user finds that the signal strength of a Wi-Fi signal at a workplace A is poor and the strength of other signals is sufficient, and finds that the signal strength of a Bluetooth signal at a workplace B is poor and the strength of other signals is sufficient. Therefore, when going to the workplace A and the workplace B, the user only needs to carry one external antenna to meet different needs. Through the communication device 2, the trouble of carrying a plurality of external antennas is avoided for the user, and whether to mount the external antenna 1081, 1082, 1083 and which connector 105 is required for mounting the external antenna 1081, 1082, 1083 according to different communication requirements.

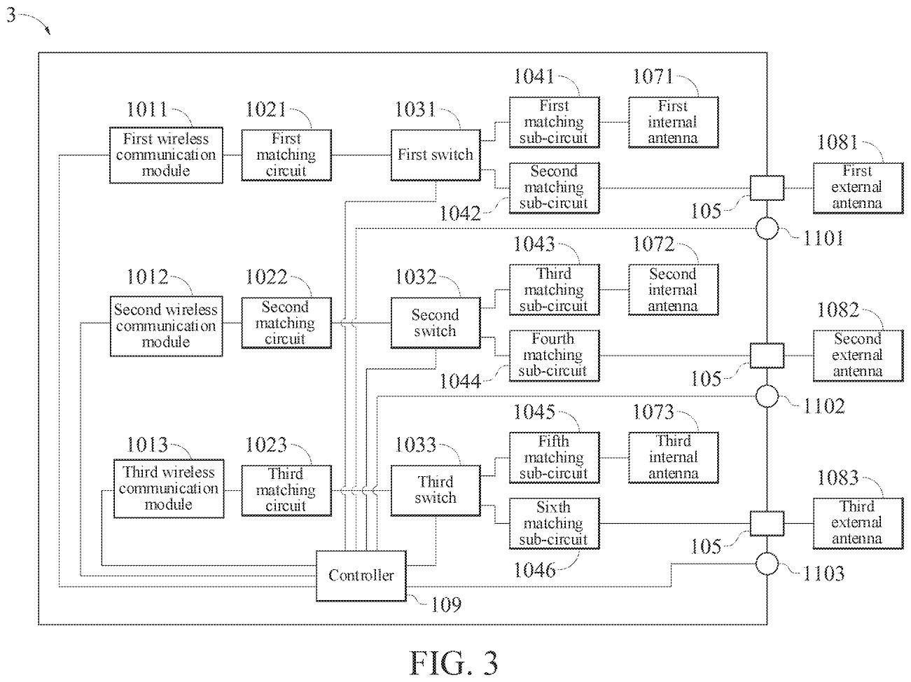

Referring to FIG. 3, in an embodiment, the communication device 3 includes a controller 109 and one group of wireless communication module 1011, switch 1031, connector 105, and internal antenna 1071. The wireless communication module 1011 is coupled to the switch 1031, and the switch 1031 is selectively coupled to the internal antenna 1071 or the connector 105. It should be noted that the coupling described in the present disclosure is not limited to a direct connection or an indirect connection.

The controller 109 may be, but is not limited to, a micro-controller unit (MCU), an application specific integrated circuit (ASIC), a field programmable gate array (FPGA), or a logic circuit.

The wireless communication module 1011 includes but is not limited to a communication module supporting communication protocols such as a global system for mobile communication (GSM), a personal handy-phone system (PHS), code division multiple access (CDMA), wideband code division multiple access (WCDMA), long term evolution (LTE), worldwide interoperability for Microwave Access (WiMAX), wireless fidelity (Wi-Fi), or Bluetooth. The wireless communication module 1011 can function as a wireless signal transmitter, a wireless signal receiver, or a wireless signal transceiver.

The switch 1031 may be, but is not limited to, a diode switch, a semiconductor switch, a radio frequency switch, a microelectromechanical switch, or a chip switch.

The connector 105 may be, but is not limited to, a bayonet Neill-Concelman (BNC) connector, a subminiature version A (SMA) connector, a reverse polarity SMA (RPSMA) connector, a UFL connector (Hirose U.FL), an ultra high frequency (UHF) connector, a threaded Neill-Concelman (TNC) connector, a reverse polarity TNC (RPTNC) connector, an I-PEX connector, or an IPX connector.

The internal antenna 1071 may be, but is not limited to, a dipole antenna, a monopole antenna, a loop antenna, a planar inverted F-antenna (PIFA), a patch antenna, a microstrip antenna, or an array antenna.

In other embodiments, a communication device 2 includes a controller 109 and a plurality of groups of wireless communication modules, switches, connectors, and internal antennas. For example, referring to FIG. 3, a communication device 3 in the embodiment in FIG. 3 includes a controller 109, a first wireless communication module 1011, a first switch 1031, a first internal antenna 1071, a second wireless communication module 1012, a second switch 1032, a second internal antenna 1072, a third wireless communication module 1013, a third switch 1033, a third internal antenna 1073, and a plurality of connectors 105. The first wireless communication module 1011 is coupled to the first switch 1031, the second wireless communication module 1012 is coupled to the second switch 1032, and the third wireless communication module 1013 is coupled to the third switch 1033. The first switch 1031 is selectively coupled to the first internal antenna 1071 or to one of the connectors 105, the second switch 1032 is selectively coupled to the second internal antenna 1072 or to one of the connectors 105, and the third switch 1033 is selectively coupled to the third internal antenna 1073 or to one of the connectors 105. The controller 109 is coupled to the first wireless communication module 1011, the second wireless communication module 1012, and the third wireless communication module 1013, and is coupled to the first switch 1031, the second switch 1032, and the third switch 1033. The first external antenna 1081, the second external antenna 1082, and the third external antenna 1083 are optionally mounted to the connectors 105 of the communication device 3. The first external antenna 1081, the second external antenna 1082, and the third external antenna 1083 are all identical external antennas. Therefore, it is possible that the first external antenna 1081 could be used as a replacement for either the second external antenna 1082 or the third external antenna 1083 if needed. In some embodiments, in order to match impedances of the antenna and the wireless communication module, a feed circuit such as a matching circuit 1021, 1022, 1023 may be respectively arranged between the wireless communication module 1011, 1012, 1013 and the corresponding switch 1031, 1032, 1033. In addition, since the internal antenna 1071, 1072, 1073 may have a different load characteristic from the first external antenna 1081, 1082, 1083, a matching sub-circuit 1041, 1043, 1045 may be arranged between the switch 1031, 1032, 1033 and the internal antenna 1071, 1072, 1073, and a matching sub-circuit 1042, 1044, 1046 may be respectively arranged between the first switch 1031, 1032, 1033 and each of the connectors 105. The configuration of matching sub-circuits may be the same or different. Progressive impedance matching may be formed between the matching circuit 1021, 1022, 1023 and the matching sub-circuit 1041, 1042, 1043, 1044, 1045, 1046, to reduce a changing amplitude of impedance between two circuits.

The external antenna may be active or passive. In some embodiments, the external antenna may be an antenna with a wide receiving bandwidth for supporting signals in different frequency bands, or may be used to support signals in the same frequency band but different communication protocols. For example, if a Wi-Fi signal and a Bluetooth signal are in the same frequency band of 2.4 GHz, the third external antenna 1083 can support a connection position of the third external antenna 1083 and the communication device 3, and a connection position of the first external antenna 1081 and the communication device 3. Therefore, the communication device 3 provides a more flexible usage situation, so that the user can determine whether to carry or mount the external antenna according to the environment. In case of no demand for the external antenna, a luggage volume occupied for carrying the external antenna can be reduced for the user, the inconvenience of carrying the external antenna can be avoided, or the cost for purchasing the external antenna can be saved.

The wireless communication module is configured to generate a signal strength indicator parameter such as a received signal strength indicator (RSSI) parameter based on a signal strength of the received wireless signal, to indicate the communication quality of the current wireless signal. That is to say, the signal strength of the wireless signal currently received by the wireless communication module through the internal antenna or the external antenna to which the wireless communication module is coupled is indicated through the RSSI parameter. The controller 109 is configured to control switching of the switch based on the signal strength indicator parameter. In some embodiments, when the switch is coupled to the internal antenna and the controller 109 determines that the signal strength indicator parameter is less than a strength lower limit, the switch is switched by the controller 109 and is coupled to the connector 105. Therefore, in the case that the connector 105 is connected to the external antenna, the wireless communication module receives, through the switch and the connector 105, the wireless signal received by the external antenna, which improves the communication quality. The strength lower limit may be defined according to a design requirement, for example, defined as −90 dbm.

In the embodiment of FIG. 3, the first wireless communication module 1011, the second wireless communication module 1012, and the third wireless communication module 1013 may support the same communication protocol or different communication protocols. The following embodiment is described by using an example that the first wireless communication module 1011 supports the Wi-Fi signal, the second wireless communication module 1012 supports the sub-GHz signal, and the third wireless communication module 1013 supports the Bluetooth signal. In this embodiment, the first wireless communication module 1011 generates a corresponding RSSI parameter according to the Wi-Fi signal, the second wireless communication module 1012 generates a corresponding RSSI parameter according to the sub-GHz signal, and the third wireless communication module 1013 generates a corresponding RSSI parameter according to the Bluetooth signal. The RSSI parameters of the three signals vary with a use environment. For example, in a home environment of the user, a Wi-Fi signal strength is −55 dbm, and a Bluetooth signal strength is −98 dbm. The controller 109 switches the third switch 1033 to a state of being coupled to the connector 105 from a state of being coupled to the third internal antenna 1073, the first switch 1031 is still coupled to the first internal antenna 1071, and the second switch 1032 is still coupled to the second internal antenna 1072. Therefore, the user only needs to mount and use the third external antenna 1083.

In some embodiments, when the switch is coupled to the connector 105 and the controller 109 determines that the signal strength indicator parameter is greater than a strength upper limit, the switch is switched by the controller 109 and is coupled to the internal antenna, to cope with a case in which signals received by some external antennas are too strong and result in a saturation of a post-stage amplifier circuit (not shown in the figure) that will cause distortion of the signals. The strength upper limit may be defined according to a design requirement, for example, may be defined as −25 dbm.

In some embodiments, the communication device 3 includes a controller 109, a wireless communication module, a switch, a connector 105, an internal antenna, and an indicator light. A quantity of indicator lights may be configured according to a quantity of internal antennas. For example, the communication device 3 in the embodiment of FIG. 3 includes three internal antennas. Therefore, a first indicator light 1101, a second indicator light 1102, and a third indicator light 1103 are correspondingly arranged. When determining that the signal strength indicator parameter is greater than or equal to the strength lower limit, the controller 109 controls the indicator light to indicate a first light signal. When determining that the signal strength indicator parameter is less than the strength lower limit, the controller 109 controls the indicator light to indicate a second light signal. The indication is not limited to actively driving the indicator light to be on with a high potential, and also includes keeping the indicator light off without supplying power. In other words, the light signal may include an off state of the indicator light. In addition, the light signal may be differentiated through parameters such as a color, a flickering frequency, or a brightness of the indicator light. For example, the first wireless communication module 1011 generates the corresponding signal strength indicator parameter after receiving the signal from the first internal antenna 1071, the controller 109 controls the first indicator light 1101 to be constant green (indicate the first light signal) when determining that the signal strength indicator parameter is greater than or equal to the strength lower limit, the controller 109 switches the first switch 1031 to the connector 105 when determining that the signal strength indicator parameter is less than the strength lower limit and that the connector 105 is connected to the external antenna, and the controller 109 controls the first indicator light 1101 to be constant red (indicate the second light signal) when determining that the signal strength indicator parameter is less than the strength lower limit and that the connector 105 is not connected to the first external antenna 1081. In this way, the user can determine a signal status by observing the indicator light, to determine whether to connect the first external antenna 1081 to the connector 105.

In some embodiments, in a period in which the first switch 1031 is coupled to the first internal antenna 1071, the controller 109 temporarily switches the first switch 1031 to the connector 105 to cause the first wireless communication module 1011 to receive the signal from the connector 105. The first wireless communication module 1011 generates the signal strength indicator parameter and transmits the signal strength indicator parameter to the controller 109, and the controller 109 compares the signal strength indicator parameter with the strength lower limit. When the connector 105 is connected to the first external antenna 1081, the first wireless communication module 1011 receives a weak current signal from the first external antenna 1081. When the connector 105 is not connected to the first external antenna 1081, the current signal received by the first wireless communication module 1011 is 0(or includes a weak current noise). The first wireless communication module 1011 generates signal strength indicator parameters indicating different degrees depending on whether the current signal is 0, and the controller 109 determines whether the connector 105 is connected to the first external antenna 1081 according to a preset strength threshold. When the signal strength indicator parameter is less than the preset strength threshold, the controller 109 determines that the connector 105 is not connected to the first external antenna 1081. In other embodiments, in the period in which the first switch 1031 is coupled to the connector 105, the controller 109 may determine the signal strength of the wireless signal from the first internal antenna 1071 by temporarily switching the first switch 1031 to the first internal antenna 1071.

In some other embodiments, when the switch is coupled to the internal antenna, the controller 109 controls the indicator light to indicate the first light signal when determining that the signal strength indicator parameter is greater than or equal to the strength lower limit, and the controller 109 controls the indicator light to indicate the second light signal when determining that the signal strength indicator parameter is less than the strength lower limit. When the switch is coupled to the connector 105, the controller 109 controls the indicator light to indicate a third light signal when determining that the signal strength indicator parameter is greater than or equal to the strength lower limit. For example, the first wireless communication module 1011 generates the signal strength indicator parameter after receiving the signal from the first internal antenna 1071. In this case, the controller 109 controls the first indicator light 1101 to be off (indicate the first light signal) when determining that the signal strength indicator parameter is greater than or equal to the strength lower limit, the controller 109 switches the first switch 1031 to the connector 105 when determining that the signal strength indicator parameter is less than the strength lower limit and that the connector 105 is connected to the first external antenna 1081, and the controller 109 controls the first indicator light 1101 to be constant red (indicate the second light signal) when determining that the signal strength indicator parameter is less than the strength lower limit and that the connector 105 is not connected to the first external antenna 1081. When the first switch 1031 is switched to the connector 105, the controller 109 controls the first indicator light 1101 to be constant green (indicate the third light signal) when determining that the signal strength indicator parameter is greater than or equal to the strength lower limit. In an embodiment, when the first switch 1031 is switched to the connector 105, the controller 109 controls the first indicator light 1101 to be green and to flicker at a first frequency (indicate a fourth light signal) when determining that the signal strength indicator parameter is still less than the strength lower limit. In this way, the user can determine the signal status by observing the indicator light, to learn whether connecting to the first external antenna 1081 helps solve the problem of poor communication quality, and determine whether to seek for a further solution.

Therefore, the arrangement of the indicator light helps the user flexibly arrange the external antenna to solve the problem of poor communication quality. For example, the communication device 3 in the embodiment of FIG. 3 includes three internal antennas, where the first wireless communication module 1011 supports the Wi-Fi signal, the second wireless communication module 1012 supports the sub-GHz signal, and the third wireless communication module 1013 supports the Bluetooth signal. When the user is in a room at home, only the first indicator light 1101 is constant red (indicates the second light signal). When the user is in the workplace, only the third indicator light 1103 is constant red (indicates the second light signal). In this case, the user only needs to purchase one external antenna to meet the use requirement at different locations.

For example, when the first indicator light 1101 and the third indicator light 1103 are constant red (indicate the second light signal), if the user currently carries only one external antenna and only has a demand for using the Wi-Fi signal, the external antenna may be mounted to the communication device 3 as the first external antenna 1081.

For example, the first indicator light 1101 and the third indicator light 1103 are constant red (indicate the second light signal), and the user currently carries only one external antenna but has a demand for using the Wi-Fi signal and the Bluetooth signal. If the user finds that the first indicator light 1101 is flickering green (indicates the fourth light signal) after mounting the external antenna to the communication device 3 as the first external antenna 1081, and finds that the third indicator light 1103 is green (indicates the third light signal) after mounting the external antenna to the communication device 3 as the third external antenna 1083, the external antenna may be used as the third external antenna 1083 and another solution for improving the communication quality of the Wi-Fi signal communication may be attempted, such as adjusting a Wi-Fi router in the room.

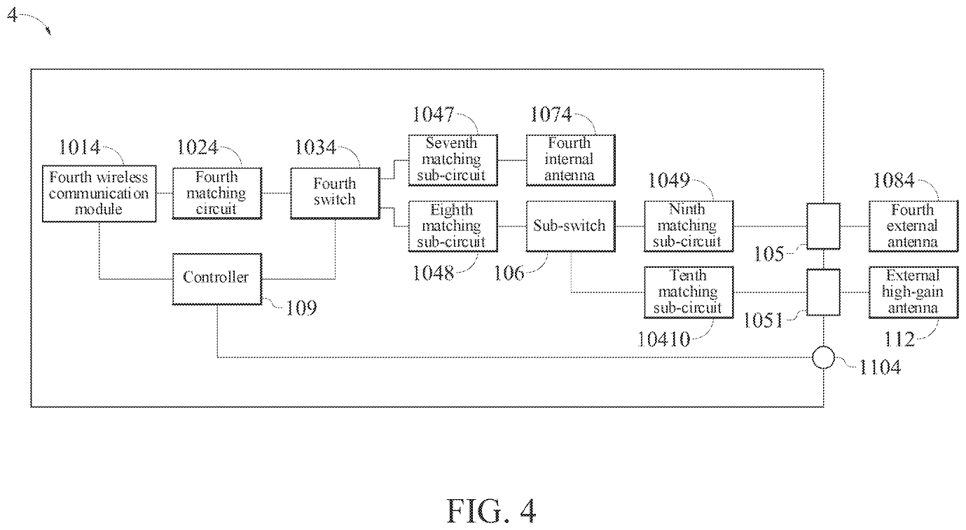

Referring to FIG. 4, in some embodiments, a communication device 4 includes a controller 109 and a fourth wireless communication module 1014, a fourth switch 1034, a fourth internal antenna 1074, a sub-switch 106, and a connector 105. The fourth wireless communication module 1014 is coupled to the fourth switch 1034, the fourth switch 1034 is selectively coupled to the fourth internal antenna 1074 or the sub-switch 106, and the sub-switch 106 is selectively coupled to the connector 105 and a high-gain connector 1051. The connector 105 and the high-gain connector 1051 have different types of connectors to meet different use requirements. For example, the connector 105 adopts an external antenna port of a normal gain type, and the high-gain connector 1051 adopts an external antenna port of a high gain type. When the fourth switch 1034 is coupled to the fourth internal antenna 1074, the fourth switch 1034 is controlled by the controller 109 to switch and to be coupled to the sub-switch 106 when the controller determines that the signal strength indicator parameter is less than the strength lower limit. When the fourth switch 1034 is coupled to the sub-switch 106 and the sub-switch 106 is coupled to the connector 105, the sub-switch 106 is controlled by the controller 109 to switch and to be coupled to the high-gain connector 1051 when the controller determines that the signal strength indicator parameter is less than the strength lower limit. In this way, the user can further arrange the external antenna according to the signal strength requirement.

In some embodiments, in order to match impedances of the antenna and the wireless communication module, a matching circuit 1024 may be arranged between the fourth wireless communication module 1014 and the fourth switch 1034. In addition, since the internal antenna and the external antenna may have different load characteristics, a seventh matching sub-circuit 1047 may be arranged between the fourth switch 1034 and the fourth internal antenna 1074, and an eighth matching sub-circuit 1048 may be arranged between the fourth switch 1034 and the sub-switch 106. In addition, since the fourth external antenna 1084 and the external high-gain antenna 112 may have different load characteristics, a ninth matching sub-circuit 1049 may be arranged between the sub-switch 106 and the connector 105, and a tenth matching sub-circuit 10410 may be arranged between the sub-switch 106 and the high-gain connector 1051.

The communication device 4 equipped with the sub-switch 106 may be further equipped with the indicator light. The communication device 4 shown in FIG. 4 is equipped with a fourth indicator light 1104 to prompt the user of a mounting requirement of the external antenna. For example, the fourth indicator light 1104 is constant red (indicates the second light signal), and the user carries only one external antenna and only one external high-gain antenna 112. If the user finds that the fourth indicator light 1104 is flickering green (indicates the fourth light signal) after mounting the external antenna to the communication device 4, the user may attempt to mount the external high-gain antenna 112 to the high-gain connector 1051 to solve the problem of poor communication quality. In an embodiment, when the sub-switch 106 is switched to the high-gain connector 1051, the controller 109 controls the first indicator light 1101 to be constant orange (indicate a fifth light signal) when determining that the signal strength indicator parameter is greater than or equal to the strength lower limit, for example, controls a red light and a green light of a dual-color LED to be on simultaneously. In an embodiment, when the sub-switch 106 is switched to the high-gain connector 1051, the controller 109 controls the first indicator light 1101 to be orange and to flicker at a fixed frequency (indicate a sixth light signal) when determining that the signal strength indicator parameter is still less than the strength lower limit. For example, the controller controls the red light and the green light of the dual-color LED to flicker simultaneously at the same frequency, so as to prompt the user to change a use environment or adjust an orientation of the communication device 4 so as to solve the problem of poor communication quality. In this way, the communication device 4 can be flexibly equipped with the fourth external antenna 1084 (the external high-gain antenna 112) in response to the different strengths of the Wi-Fi signal and the Bluetooth signal in the environment.

The advantages of the flexible configuration are even more significant in a multi-channel architecture. For example, the first indicator light 1101 and the third indicator light 1103 are constant red (indicate the second light signal), and the user currently carries only one external antenna and one external high-gain antenna 112 but has the demand for using the Wi-Fi signal and the Bluetooth signal. If the user finds that the indicator light corresponding to the Wi-Fi signal is flickering green (indicates the fourth light signal) after mounting the external antenna to the communication device 4, and finds that the indicator light corresponding to the Bluetooth signal is constant green (indicates the third light signal) after mounting the external antenna to the communication device 4, the external antenna may be mounted to the connector 105 corresponding to the Bluetooth signal. In addition, the external high-gain antenna 112 may be arranged on the high-gain connector 1051 corresponding to the Wi-Fi signal in response to a strength difference between the Wi-Fi signal and the Bluetooth signal, so as to solve the problem of poor communication quality of the communication device 4 when receiving and transmitting different signals.

In some embodiments, the controller 109 regularly receives the signal from the internal antenna, and the controller 109 receives the signal from the internal antenna according to a control signal when a preset time point is reached. Alternatively, the communication device 3 may include a removable antenna search button, and the removable antenna search button generates a control signal when pressed. The controller 109 receives the signal from the internal antenna according to the control signal. When the controller determines that a signal strength indicator parameter received from the internal antenna is greater than or equal to the strength lower limit, the switch is controlled to switch and to be coupled to the internal antenna. For example, referring to FIG. 3, after the user mounts the first external antenna 1081 to the connector 105 at home to solve the problem of poor communication of the Wi-Fi signal in the room, the user carries the communication device 3 to the workplace. Since the Wi-Fi signal strength in the workplace is different from the Wi-Fi signal strength at home, the user may first press the removable antenna search button to determine an external antenna currently connected to the communication device 3 may be removed. When the controller 109 receives a control signal from the removable antenna search button, the controller 109 switches the switches one by one to receive signals from the internal antennas corresponding to the switches. When the controller 109 determines that a strength of the signal received from the first internal antenna 1071 is greater than or equal to the strength lower limit, it indicates that communication quality of the Wi-Fi signal in the workplace is well. Therefore, the first switch 1031 is switched by the controller 109 and is coupled to the first internal antenna 1071 (or remains coupled to the first internal antenna 1071). In this way, the first external antenna 1081 can be removed to reduce an overall volume of the communication device 3 and the external antenna, or the first external antenna 1081 may be used for other purposes.

In some embodiments, the communication device 3 includes an indicator light. When determining that the signal strength indicator parameter is greater than or equal to the strength lower limit and that the connector 105 is connected to the external antenna, the controller 109 controls the indicator light to indicate a first removal light signal, to prompt the user that the external antenna may be removed. For example, referring to FIG. 3, when determining that the signal strength indicator parameter from the first internal antenna 1071 is less than the strength lower limit, the controller 109 switches the first switch 1031 to the connector 105. The first external antenna 1081 may be arranged on the connector 105. In this case, when determining that the signal strength indicator parameter from the first external antenna 1081 is greater than or equal to the strength lower limit, the controller 109 controls the first indicator light 1101 to be constant green (indicate the third light signal). In this period, when the controller 109 receives the control signal from the removable antenna search button, the controller temporarily switches the first switch 1031 to the first internal antenna 1071 to receive the signal from the first internal antenna 1071. If determining that the signal strength indicator parameter from the first internal antenna 1071 is greater than or equal to the strength lower limit, the controller 109 controls the first indicator light 1101 to be red and to flicker at a second frequency (indicate the first removal light signal). Therefore, when the first external antenna 1081 is connected to the communication device 3, the first indicator light 1101 is switched to the first removal light signal from the third light signal, to prompt the user that the first external antenna 1081 may be removed.

Referring to FIG. 4, in some embodiments, in the period in which the sub-switch 106 is switched to the high-gain connector 1051, when receiving the control signal from the removable antenna search button, the controller 109 temporarily switches the fourth switch 1034 to the fourth internal antenna 1074 to receive the signal from the fourth internal antenna 1074. If determining that the signal strength indicator parameter from the fourth internal antenna 1074 is greater than or equal to the strength lower limit, the controller 109 controls the fourth indicator light 1104 to be red and to flicker at the second frequency (indicate a second removal light signal). Therefore, when the external high-gain antenna 112 is connected to the communication device 3, the fourth indicator light 1104 is switched to the second removal light signal from the fifth light signal, to prompt the user that the external high-gain antenna 112 may be removed.

In some embodiments, in a period in which the sub-switch 106 is switched to the connector 105, the controller 109 generates a corresponding control signal according to an input signal received from the removable antenna search button, and then temporarily switches the sub-switch 106 to the high-gain connector 1051 to receive the signal from the external high-gain antenna 112 through the high-gain connector 1051. If determining that a signal from the high-gain connector 1051 exists (for example, the potential is not 0), the controller 109 controls the fourth indicator light 1104 to be orange and to flicker at the second frequency (indicate a third removal light signal). Therefore, when the external high-gain antenna 112 and the fourth external antenna 1084 are both connected to the communication device 3 and the fourth external antenna 1084 is being used, the fourth indicator light 1104 is switched to the third removal light signal from the fifth light signal, to prompt the user that the external high-gain antenna 112 may be removed.

In some embodiments, in the period in which the sub-switch 106 is switched to the high-gain connector 1051, when receiving the control signal from the removable antenna search button, the controller 109 temporarily switches the sub-switch 106 to the connector 105 to receive the signal from the fourth external antenna 1084 through the connector 105. If determining that a signal from the connector 105 exists (for example, the potential is not 0), the controller 109 controls the fourth indicator light 1104 to be red and to flicker at the second frequency (indicate a fourth removal light signal). Therefore, when the external high-gain antenna 112 and the fourth external antenna 1084 are both connected to the communication device 3 and the external high-gain antenna 112 is being used, the fourth indicator light 1104 is switched to the fourth removal light signal from the fifth light signal, to prompt the user that the fourth external antenna 1084 may be removed.

What is claimed is:

1. A communication device, adapted to be coupled to an external antenna configured to receive a wireless signal in a first frequency band, the communication device comprising:
a first connector, adapted to be coupled to the external antenna;
a first internal antenna, configured to receive the wireless signal in the first frequency band;
a first switch, selectively coupled to the first connector or the first internal antenna;
a first wireless communication module, coupled to the first switch, wherein the first wireless communication module is configured to generate a first signal strength indicator parameter based on the wireless signal in the first frequency band; and
a controller, configured to control switching of the first switch based on the first signal strength indicator parameter.

2. The communication device according to claim 1, wherein when the first switch is coupled to the first internal antenna, the first switch is controlled by the controller to switch and to be coupled to the first connector and the first wireless communication module when the controller determines that the first signal strength indicator parameter is less than a first strength lower limit.

3. The communication device according to claim 1, further comprising a first indicator light, wherein the controller controls the first indicator light to indicate a first light signal when determining that the first signal strength indicator parameter is greater than or equal to a first strength lower limit, and the controller controls the first indicator light to indicate a second light signal when determining that the first signal strength indicator parameter is less than the first strength lower limit.

4. The communication device according to claim 3, wherein when the first switch is coupled to the first internal antenna and the first wireless communication module, the controller controls the first indicator light to indicate the first light signal when determining that the first signal strength indicator parameter is greater than or equal to the first strength lower limit; and when the first switch is not electrically connected to the internal antenna or the first wireless communication module and the first switch is coupled to the first connector and the first communication module, the controller controls the first indicator light to indicate a third light signal when determining that the first signal strength indicator parameter is greater than or equal to the first strength lower limit.

5. The communication device according to claim 1, wherein the external antenna is further configured to receive a wireless signal in a second frequency band, and the communication device further comprises:
a second connector, adapted to be coupled to the external antenna;
a second internal antenna, configured to receive the wireless signal in the second frequency band;
a second switch, selectively coupled to the second connector or the second internal antenna; and
a second wireless communication module, coupled to the second switch, wherein the second wireless communication module is configured to generate a second signal strength indicator parameter based on the wireless signal in the second frequency band; and
the controller is configured to control switching of the second switch based on the second signal strength indicator parameter.

6. The communication device according to claim 5, further comprising a first indicator light and a second indicator light, wherein the controller controls the first indicator light to indicate a first light signal when determining that the first signal strength indicator parameter is greater than or equal to a first strength lower limit, the controller controls the first indicator light to indicate a second light signal when determining that the first signal strength indicator parameter is less than the first strength lower limit, the controller controls the second indicator light to indicate the first light signal when determining that the second signal strength indicator parameter is greater than or equal to a second strength lower limit, and the controller controls the second indicator light to indicate the second light signal when determining that the second signal strength indicator parameter is less than or equal to the second strength lower limit.

7. The communication device according to claim 5, wherein the first wireless communication module and the second wireless communication module support different communication protocols.

8. The communication device according to claim 1, further comprising:
a third connector, adapted to be coupled to an external high-gain antenna, wherein the external high-gain antenna is configured to receive the wireless signal in the first frequency band; and
a sub-switch, wherein the first switch is selectively coupled to the sub-switch, and the sub-switch is selectively coupled to the first connector or the third connector; and
when the first switch is coupled to the first internal antenna, the first switch is controlled by the controller to switch and to be not electrically connected to the first wireless communication module and the first internal antenna but to be coupled to the sub-switch and the first wireless communication module when the controller determines that the first signal strength indicator parameter is less than a first strength lower limit; and when the first switch is coupled to the sub-switch and the sub-switch is coupled to the first connector, the sub-switch is controlled by the controller to switch and to be not electrically connected to the first switch and the first connector but to be coupled to the first switch and the third connector when the controller determines that the first signal strength indicator parameter is less than the first strength lower limit.

9. The communication device according to claim 8, further comprising a first indicator light, wherein when the first switch is coupled to the first internal antenna, the controller controls the first indicator light to indicate a first light signal when determining that the first signal strength indicator parameter is greater than or equal to the first strength lower limit, and the controller controls the first indicator light to indicate a second light signal when determining that the first signal strength indicator parameter is less than the first strength lower limit; and when the first switch is coupled to the sub-switch, the controller controls the first indicator light to indicate a third light signal when determining that the first signal strength indicator parameter is greater than or equal to the first strength lower limit.

10. The communication device according to claim 8, further comprising a removable antenna search button, wherein when the first switch is coupled to the sub-switch and the sub-switch is coupled to the first connector, the controller temporarily switches the sub-switch to the third connector in response to a control signal generated by the removable antenna search button, so that the first wireless communication module receives the wireless signal in the first frequency band from the external high-gain antenna.

11. The communication device according to claim 10, further comprising a first indicator light, wherein the controller controls the first indicator light to indicate a third removal light signal when determining that a signal from the third connector exists.

12. The communication device according to claim 8, wherein when the first switch is coupled to the sub-switch and the sub-switch is coupled to the first connector, the controller temporarily switches the sub-switch to the third connector in response to a preset time point to couple the third connector to the first switch, so that the third connector is coupled to the first communication module through the first switch, and the first wireless communication module receives the wireless signal in the first frequency band from the external high-gain antenna.

13. The communication device according to claim 8, further comprising a removable antenna search button, wherein when the first switch is coupled to the sub-switch and the sub-switch is coupled to the third connector, the controller temporarily switches the sub-switch to the first connector in response to a control signal generated by the removable antenna search button, so as to temporarily electrically couple the first connector to the first switch through the sub-switch, so that the first wireless communication module is electrically coupled to the first connector through the first switch and the sub-switch, and the first wireless communication module receives the wireless signal in the first frequency band from the external antenna.

14. The communication device according to claim 13, further comprising a first indicator light, wherein the controller controls the first indicator light to indicate a fourth removal light signal when determining that a signal from the first connector exists.

15. The communication device according to claim 8, wherein when the first switch is coupled to the sub-switch and the sub-switch is coupled to the third connector, the controller temporarily switches the sub-switch to the first connector in response to a preset time point, so as to temporarily electrically couple the first connector to the first switch through the sub-switch, so that the first wireless communication module is electrically coupled to the first connector through the first switch and the sub-switch, and the first wireless communication module receives the wireless signal in the first frequency band from the external antenna.

16. The communication device according to claim 1, wherein the controller regularly determines whether the first signal strength indicator parameter received from the first internal antenna is greater than or equal to a first strength lower limit, and when the first signal strength indicator parameter is greater than or equal to the first strength lower limit, the first switch is controlled by the controller to switch and to be coupled to the first internal antenna.

17. The communication device according to claim 16, wherein the controller temporarily switches the first switch to the first internal antenna in response to a preset time point, so as to electrically couple the first wireless communication module to the first internal antenna through the first switch, so that the first wireless communication module receives the wireless signal in the first frequency band from the first internal antenna.

18. The communication device according to claim 1, further comprising a removable antenna search button, wherein the controller determines whether the first signal strength indicator parameter received from the first internal antenna is greater than or equal to a first strength lower limit in response to a control signal generated by the removable antenna search button, and the first switch is controlled by the controller to switch and to be coupled to the first internal antenna when the first signal strength indicator parameter is greater than or equal to the first strength lower limit.

19. The communication device according to claim 18, further comprising a first indicator light, wherein the controller controls the first indicator light to indicate a first light signal when determining that the first signal strength indicator parameter is greater than or equal to the first strength lower limit.

20. The communication device according to claim 18, wherein the controller temporarily switches the first switch to the first internal antenna in response to the control signal generated by the removable antenna search button, so that the first wireless communication module receives the wireless signal in the first frequency band from the first internal antenna.
